(19) United States
(12) Patent Application Publication
(10) Pub. No.: US 2013/0097203 A1
(43) Pub. Date: Apr. 18, 2013

(54) SYSTEM AND METHOD FOR PROVIDING THRESHOLD LEVELS ON PRIVILEGED RESOURCE USAGE IN A MOBILE NETWORK ENVIRONMENT

(71) Applicants: Rajbir Bhattacharjee, Lajpat Nagar (IN); Balbir Singh, Gurgaon (IN)

(72) Inventors: Rajbir Bhattacharjee, Lajpat Nagar (IN); Balbir Singh, Gurgaon (IN)

(73) Assignee: McAfee, Inc.

(21) Appl. No.: 13/271,493

(22) Filed: Oct. 12, 2011

(51) Int. Cl. G06F 17/30

(52) U.S. Cl. 707/783; 707/E17.005

(57) ABSTRACT

A system and method in one embodiment includes modules for detecting a request by an application in a mobile device to access a privileged resource, determining a cumulative usage of the privileged resource by the application, and performing an action according to a rule if a predefined threshold level of usage triggers the action based on the cumulative usage. More specific embodiments include blocking the request, and sending a notification to a user and updating a rules database to modify the predefined threshold level of usage associated with the rule. Other embodiments include monitoring permissions of the application to the privileged resource, and removing any permissions that have not been used for a predefined time period, logging the request into a log in a utilization database, reading the log, collating information in the log, and analyzing the log.

### TECHNICAL FIELD

This disclosure relates in general to the field of computer networks and communication and, more particularly, to a system and method for providing threshold levels on privileged resource usage in a mobile network environment.

### BACKGROUND

The field of computer network security has become increasingly important and complicated in today's society. Computer network environments are configured for virtually every enterprise or organization, typically with multiple interconnected computers (e.g., end user computers, laptops, servers, printing devices, etc.). In many such enterprises, Information Technology (IT) administrators may be tasked with maintenance and control of the network environment, including executable software files (e.g., web application files) on hosts, servers, and other network computers. As the number of executable software files in a network environment increases, the ability to control, maintain, and remediate these files efficiently can become more difficult.

Moreover, hackers are targeting computer networks and users' sensitive information through mobile devices. Hackers' appetites for the mobile channel are rising, with one third of smartphone users now accessing the Internet from their mobile devices. Mobile devices are among the fastest growing consumer technology, and a variety of mobile applications are popular in the mobile channel. As mobile devices have grown in popularity, so have hackers' interests in these devices. Mobile malware, for example, is on the rise, as attackers target mobile phones. Yet, the balance of innovation versus security in the mobile space is being challenged by the industry's desire to attract more developers. Providing open access to application development can drive developer attention and open the door for technology abuse at the same time. Competition among mobile platforms is high, putting pressure on shorting content approval cycles and simplifying pre-launch security checks to boost developer time-to-market. The trend of mobile user concentration, opening device platforms and shortened security procedures raises security threats to computer networks and users' privacy from vulnerabilities in mobile devices.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating components of a system for threshold levels on privileged resource usage according to an example embodiment;

FIG. 2 is a simplified flow-chart illustrating example operational steps that may be associated with embodiments of the present disclosure;

FIG. 3 is a simplified block diagram illustrating components of the system according to another embodiment of the present disclosure; and

FIG. 4 is a simplified flow-chart illustrating example operational steps that may be associated with embodiments of the present disclosure.

### DETAILED DESCRIPTION OF EXAMPLE EMBODIMENTS

### Overview

A system and method in an example embodiment includes modules for detecting a request by an application in a mobile device to access a privileged resource, determining a cumulative usage of the privileged resource by the application, and performing an action according to a rule if a predefined threshold level of usage triggers the action based on the cumulative usage. More specific embodiments include blocking the request, sending a notification to a user, and updating a rules database to modify the predefined threshold level of usage associated with the rule. In an example embodiment, the predefined threshold level of usage triggers the action if the cumulative usage occurs within a predefined amount of time. In another example embodiment, the predefined threshold level of usage triggers the action if the cumulative usage exceeds the predefined threshold level of usage.

Other embodiments include logging the request into a log in a utilization database, reading the log, collating information in the log, and analyzing the log. An example embodiment includes monitoring permissions of the application to the privileged resource, and removing any permissions that have not been used for a predefined time period. The user may be notified if the application has not used a permission for the predefined time. Other specific embodiments include sending a notification to the user if there are no rules applicable to the request and other features.

### Example Embodiments

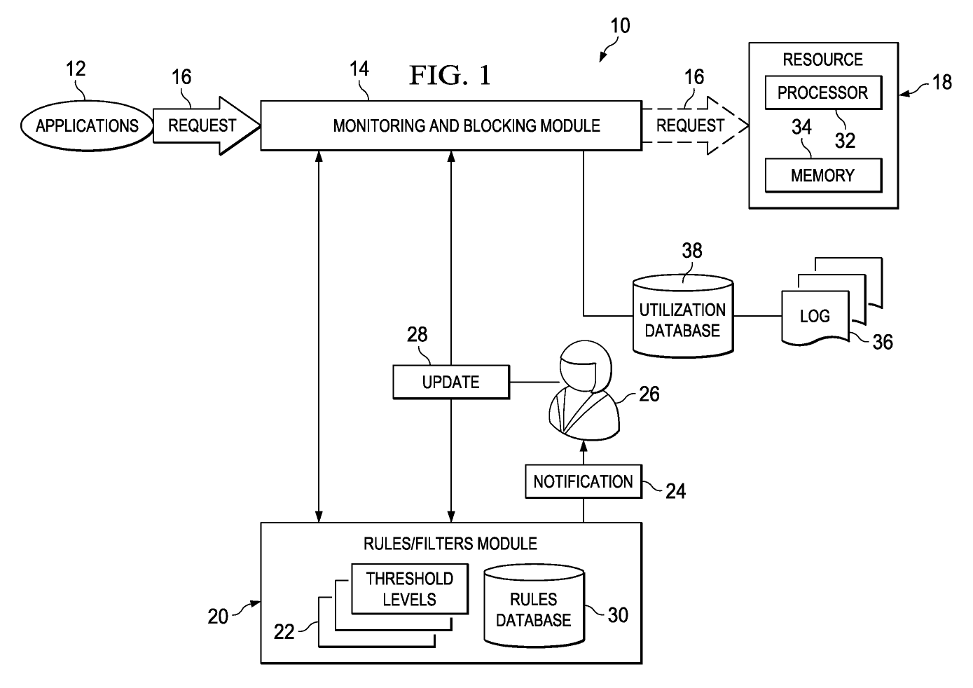

FIG. 1 is a simplified block diagram illustrating an example implementation of a system 10 for providing threshold levels on privileged resource usage in a mobile network environment. A mobile device may be provisioned with one or more applications 12. An application includes application software that runs on (or is capable of running on) mobile devices and performs specific tasks for the mobile device's user. Applications 12 may include native applications pre-installed on the mobile device, such as address books, calendars, calculators, games, maps and Web browsers. Applications 12 may also be downloaded from various mobile application software distribution platforms such as Google® Android Market, Apple® App Store, Palm® Software Store and App Catalog, RIM® App World, etc. According to embodiments of the present disclosure, mobile devices are inclusive of mobile phones, smart mobile phones (smartphones), e-book readers, tablets, iPads, personal digital assistants (PDAs), laptops or electronic notebooks, portable navigation systems, multimedia gadgets (e.g., cameras, video and/or audio players, etc.), gaming systems, other handheld electronic devices, and any other similar device, component, element, or object capable of initiating voice, audio, video, media, or data exchanges.

A monitoring and blocking module 14 may be provisioned to intercept one or more requests 16 from applications 12 to access one or more resources 18 (user herein in the singular as resource 18 to refer to any one of the resources). As used herein, the term “access” includes open, create, read, write, modify, delete, execute, or use. As used herein, the term “resource” includes any physical or virtual component within a mobile device, such as processors, memory, files, data structures, network connections, camera, microphone, etc. The term “resource” also includes any source of data, such as files, registry data, e-mails, SMS, browser cookies, browser history, etc. Data, as used herein in this specification, refers to any type of numeric, voice, video, graphic, or script data, or any type of source or object code, or any other suitable information in any appropriate format that may be communicated from one point to another in electronic devices and/or networks. For example, application 12 can send request 16 to an email program to open an email attachment. In another example, application 12 can send request 16 to a port to send data over a wireless network. In yet another example, application 12 can send request 16 to a storage disk to write into a file stored thereon.

Resources 18 may be privileged (i.e., require permission to access). Examples of various privileges include the ability to create a file, read or write into a file, use a device resource such as a camera, read or write to a socket for network communication, etc. Privileges can be automatic (e.g., applications 12 may be automatically granted permission to access memory 34), or granted (e.g., a user may grant applications 12 permission to access a list of contacts in the mobile device). Monitoring and blocking module 14 may apply rules from rules/filters module 20 to requests 16. Rules can include conditionally executed actions based on occurring events. An example of a rule may include blocking an outgoing email containing a file that is larger than a predefined threshold size (e.g., 10 MB). Rules may also include filters. For example, a rule may specify a filter that filters requests based on a request attribute, such as a read attribute (e.g., read request) or a send attribute (e.g., send request). In another example, a rule may be set to filter all requests from a specific application.

The rules may be associated with one or more threshold levels 22 (used herein in the singular as threshold level 22 to refer to any one of the threshold levels). As used herein, the term “threshold level” constitutes a limit that can trigger actions (e.g., blocking a send request, terminating a process, logging, etc.). The actions triggered by threshold level 22 may be specified by the rules in rules/filters module 20 and can be implemented in any suitable manner (e.g., system 10 may be configured to trigger actions if a threshold level is exceeded, met, not exceeded, not met, etc.).

Threshold level 22 may be implemented on any measurable property or parameter associated with resource 18, such as file size, network data size, central processing unit (CPU) usage (e.g., time and/or amount), number of short message service (SMS) messages, number of permissions in applications 12, etc. According to embodiments of the present disclosure, components of system 10 may set threshold levels 22 on privileged resource usage (e.g., camera, network etc.) and privileged information access (e.g., reading browser history, reading SMSs etc.) on mobile devices. Some threshold levels 22 may be integrated with a time component (e.g., at least 50 SMS messages sent each day for a certain number of days, 50% CPU usage for greater than 5 minutes, a granted permission not used within a week, etc.). System 10 can notify user 26 regarding privileged resource usage to enable various types of possible intervention, if threshold levels 22 of such resource usage indicate intervention may be needed.

The rules may be changed, updated, or created by notifying user 26 for possible intervention. In an example embodiment, the rules may specify that a notification 24 may be sent to a user 26. In one example, if there are no rules applicable to request 16, a default rule may specify that notification 24 may be sent to user 26. In another example, rules/filters module 20 may send notification 24 to user 26 for any updates that may be desired to the rules. User 26 may send an update 28 directly to monitoring and blocking module 14, and/or update the rules in rules/filters module 20. If request 16 is permitted by rule/filter module 20, or by an update 28, request 16 may be forwarded to resource 18 as appropriate for further processing.

Rules/filters module 20 may include a rules database 30. Rules database 30 may comprise rules used by rules/filters module 20 for processing requests 16. Monitoring and blocking module 14 and rules/filters module 20 may use one or more processors 32 and one or more memory 34 to perform their intended functions. Processors 32 and memory 34 may be part of resource 18. Monitoring and blocking module 14 may also log requests 16 into one or more logs 36 in a utilization database 38.

For purposes of illustrating the techniques of system 10, it is important to understand the activities and security concerns that may be present in a given system such as the system shown in FIG. 1. The following foundational information may be viewed as a basis from which the present disclosure may be properly explained. Such information is offered earnestly for purposes of explanation only and, accordingly, should not be construed in any way to limit the broad scope of the present disclosure and its potential applications.

In general, downloadable and native applications can present many security threats on mobile devices. Some applications may be specifically designed to be malicious, and some other applications may be easily exploited for malicious purposes. Application-based threats generally fit into one or more of the following categories: (1) malware; (2) spyware; (3) privacy threat; and (4) vulnerable applications. Malware is software that is designed to engage in malicious and/or unwanted behavior on a device. For example, malware can commonly perform actions without a user's knowledge, such as making charges to the user's phone bill, sending unsolicited messages to the user's contact list, or giving an attacker remote control over the device. Malware can also be used to steal personal information from a mobile device that could result in identity theft or financial fraud.

Spyware is software that is designed to collect or use data without a user's knowledge or approval. For example, spyware may automatically trigger a camera's phone or microphone, record conversations, record locations, etc. and send the collected information to a remote recipient. Privacy threats may be caused by applications that may not be necessarily malicious, but gather or use information (e.g., location, contact lists, personally identifiable information) that is unnecessary to perform their primary functions. Vulnerable applications can contain software vulnerabilities that can be exploited for malicious purposes. For example, vulnerabilities can often allow an attacker to access sensitive information, perform undesirable actions, stop a service from functioning correctly, automatically download malicious software, or otherwise engage in undesirable behavior.

Typically, hackers can use the vulnerabilities in mobile devices to access information on the mobile devices and on devices in a connected network, such as computer networks, and send the accessed information to remote locations surreptitiously. For example, mobile phone technologies, such as Android operating system (OS), provide a rich application programming framework, which allows application developers to get access to a variety of data like SMS's, phone logs, contact lists, web browsing history, etc. in the mobile devices if they have relevant permissions. Resources of a mobile phone can also be exploited. For example, malware could send spam mail or unsolicited emails by abusing a user's mobile phone. In another example, a legitimate application may request and receive permission to access information and resources, and an attack on the legitimate application could misuse those permissions. The framework also allows applications to access resources such as an available network, a camera, etc., by requesting permissions.

Generally, applications explicitly request the user for permission (typically during installation) to access information and resources. However, a user who is not technologically savvy may not understand how these permissions are used by the applications. Even if the user is technologically savvy, s/he may not understand how and when the permissions are used through the life time of the application. Moreover, some applications may require permissions for advertising (location/Internet access) to perform their primary function; however, without adequate controls, the private or sensitive information may be sent to unauthorized recipients as well. It may be hard to differentiate legitimate permissions from illegitimate ones. Applications may not immediately behave maliciously upon installation; sensitive information (e.g., SMS's with financial information, IMEI number, IMSI number, phone numbers, etc.) may be sent out many days after the application is installed without the user noticing information that is being leaked.

Application-based threats are typically dependent on operating systems, and may affect some operating systems more than others. For example, some malware and spyware target devices operating on Android OS. Android OS tries to provide a level of protection by asking the user to validate certain permissions like SMS receive/send internet access, etc. However, this information is not sufficient for the user to make a deterministic decision on the threat the application poses.

One solution currently available for the Android OS provides a taint tracking and analysis system capable of simultaneously tracking multiple sources of sensitive data. The solution provides real time analysis by leveraging Android OS's virtualized execution environment. The solution modifies the Android OS's application verification platform to track the flow of privacy sensitive information by automatically labeling data from privacy-sensitive sources. When labeled data is transmitted over the network, or otherwise leaves the mobile device, the solution logs the data's labels, the application responsible for transmitting the data, and the data's destination. However, the solution does not prevent the applications from sending the sensitive data. Moreover, users may be disturbed as they are informed any time the data has been sent. The solution may also add a significant overhead. Typical mobile devices can not tolerate the platform changes required and overheads of the solution.

A system for providing threshold levels on privileged resource usage outlined by FIG. 1 can resolve these issues, among others. Embodiments of the present disclosure seek to vastly improve capabilities of existing technologies to allow for a more robust solution. The example embodiment of FIG. 1 illustrates active intervention, wherein at each request to access a privileged source of information, or each use of a privileged resource, the cumulative usage of that particular resource or source of information for the application may be collected, and threshold levels applied. As used herein, “cumulative usage” of a resource is a sum of usage of the resource. Cumulative usage may be absolute (e.g., sum of number of times a resource is used), or alternatively, may be calculated over any desired parameter, such as time (e.g., sum of usage over a predefined time period), sessions (e.g., sum of usage over a discrete number of sessions), etc. If required, the user can be notified that the application has reached the threshold level on usage of a particular resource or source of information. The user can then choose a relevant action to be taken. The user may provide feedback to the system by modifying the rules if there is a perceived need to do so. Components of system 10 may not allow the request to pass through if the rules specify that the request should be blocked.

In example embodiments, components of system 10 may set threshold levels 22, and user 26 may be notified whenever requests 16 from applications 12 exceed threshold levels 22. In an example embodiment, user 26 may set threshold level 22 for an applicable rule. For example, rules/filters module 20 may present a rule to user 26 to set a file size threshold level for outgoing email attachments. In another example embodiment, threshold level 22 may be set automatically according to a rule and/or filter set by user 26. For example, user 26 may set a rule for energy savings. The rule may automatically set threshold level 22 for battery usage at 50%.

According to one embodiment, each request 16 by application 12 to access privileged resources 18 may be intercepted and subjected to one or more rules, for example, including threshold level 22. User 26 may be notified appropriately, for example, when request 16 indicates that applicable threshold level 22 (e.g., on usage of a particular resource 18) has been reached. User 26 may choose a suitable action to take regarding request 16. According to another embodiment, each request 16 by application 12 to access privileged resources 18 may be entered into log 36 of utilization database 38.

In an example embodiment, network data sent by applications 12 may be monitored and threshold level 22 set in rules/filters module 20. For example, threshold level 22 for outgoing network data may be set at 5 kb per day, and if application 12 exceeds 5 kb of network data, user 26 may be notified (e.g., via notification 24). Assume, for the sake of illustration, that a malicious application 12 uses the mobile device to send out spam advertisement emails to recipients listed on a contact list. Malicious application 12 may send request 16 to resource 18 comprising a network interface, requesting to send the spam advertisement over the network. Monitoring and blocking module 14 may collect information about the amount of network data that malicious application 12 is sending over a period of time, compare the collected information with threshold level 22, and block request 16 if threshold level 22 is exceeded. In an example embodiment, rules/filters module 20 may inform user 26 via notification 24 that application 12 has exceeded threshold level 22. User 26 can modify the rule to increase threshold level 22 for application 12, or blacklist application 12 so that it cannot use the network in the future, or if user 26 determines that application 12 is malicious, then application 12 can be uninstalled from the mobile device.

In another example embodiment, threshold level 22 for processor usage may be set at 5% over a 5 minute period, so that if application 12 exceeds threshold level 22 in processor usage, user 26 may be notified (e.g., via notification 24). Assume, for the sake of illustration, that user 26 installs application 12, which uses 50% of processor 32. Monitoring and blocking module 14 may intercept request 16 to access processor 32, compare processor usage with threshold level 22, and block request 16 if threshold level 22 has been exceeded. In an example embodiment, rules/filters module 20 may inform user 26 via notification 24 that application 12 has exceeded threshold level 22. Further requests 16 to access processor 32 may be blocked waiting for user intervention.

In yet another example embodiment, user 26 may unintentionally install a malware application 12 from a marketplace. For example, application 12 may masquerade as a legitimate game. However, the primary function of application 12 may be to send spam short message services (SMSs) to other phones from the mobile device. For example, every day, application 12 may send out 50 SMSs from the mobile device. Threshold level 22 may be set to monitor the number of SMSs sent from the mobile device. Further threshold levels 22 can take into consideration a number of SMSs sent to contacts in the user's address book, and the number of SMSs sent to people outside the user's address book. Once user 26 is notified of the activity, user 26 can disallow application 12 (or any other application) from sending SMSs to contacts other than those present in the mobile device's address book; disallow application 12 from sending SMSs to contacts in the user's address book; uninstall application 12; and/or block application 12 from sending any further SMSs.

In yet another example embodiment, user 26 may install application 12 that requests numerous permissions to access various privileged resources. However, application 12 may rarely, if ever, use some of the permissions that it has requested. A rule may be set to send notification 24 to user 26 if application 12 has not used a granted permission for a predefined time period (e.g., at least a week). Monitoring and blocking module 14 may monitor the permissions used by application 12 over the predefined time period. If any permissions have not been used for over the predefined time period, user 26 may be notified. User 26 can then remove the unused permission from application 12. This may ensure that if any vulnerability exists in application 12, then an exploit cannot gain access to any resource 18 protected by the permission.

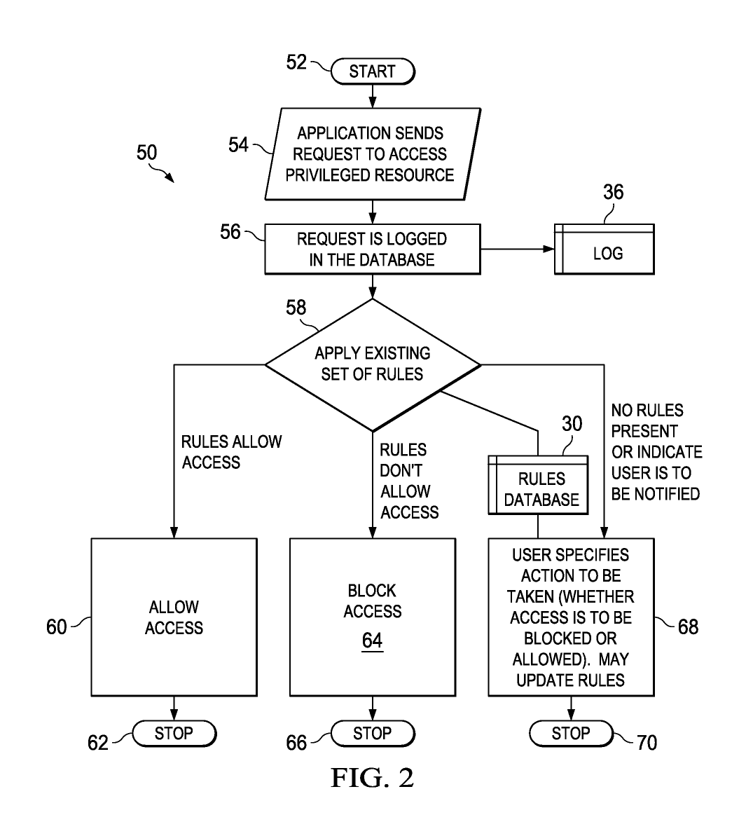

Turning to FIG. 2, FIG. 2 is a simplified flow-chart illustrating example operational steps that may be associated with embodiments of the present disclosure. Embodiments of the present disclosure may intervene in application communications (e.g., requests 16) with an operating system of the mobile device, apply rules, and notify user 26 if required. User 26 may then provide feedback to system 10 by modifying the rules if needed. Components of system 10 may not allow request 16 to pass through if the rules suggest that the request should be blocked.

Operations 50 may begin in 52, when system 10 is activated. In 54, application 12 sends request 16 to access resource 18. In 56, request 16 is logged into log 36 in utilization database 38. In 58, existing set of rules may be applied from rules database 30. If rules allow access, monitoring and blocking module 14 may allow the access to proceed in 60 and the operations may stop at 62. On the other hand, if the rules do not allow access, the access may be blocked in 64 and the operation stops in 66. If no rules are present, or rules indicate user 26 should be notified, then when user 26 is notified, user 26 may specify an action to be taken in 68. For example, user 26 may block or allow access, or may update the rules in rules database 30. The operations may stop in 70.

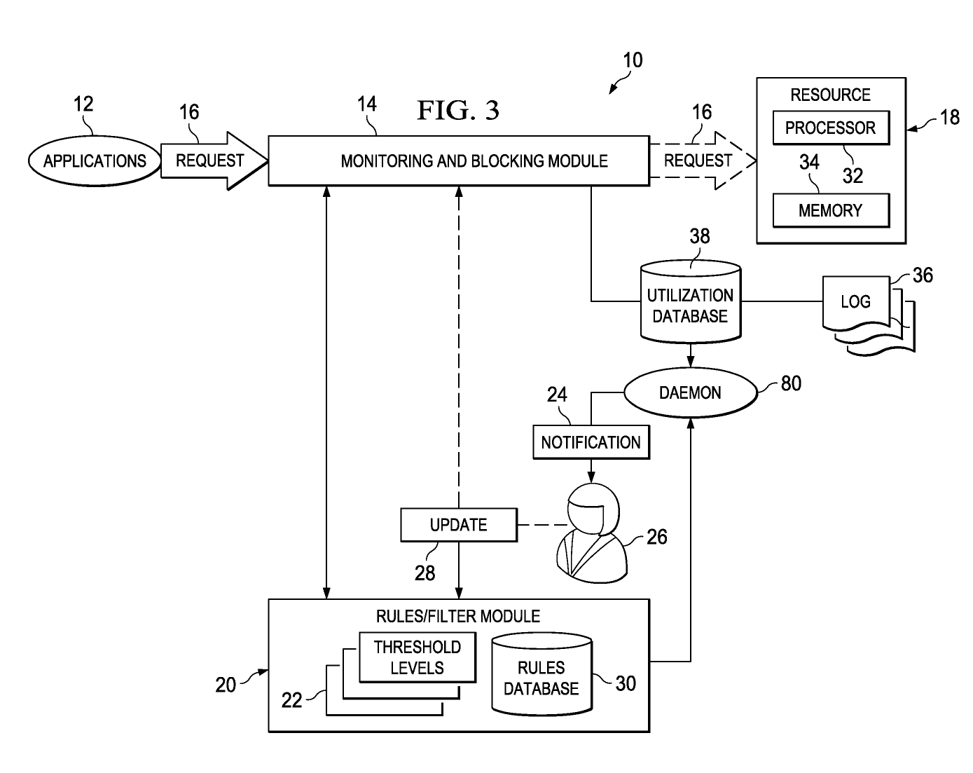

Turning to FIG. 3, FIG. 3 is a simplified block diagram illustrating another example implementation of a system 10 for providing threshold levels on privileged resource usage. The example embodiment of FIG. 3 illustrates passive intervention, wherein at each request to access a privileged source of information, or each use of a privileged resource, an entry to a database (maintained by system 10) may be made. At specific time periods (e.g., regular intervals), a background daemon may read the database, collate the entries, and notify the user as and when required. The user can provide feedback regarding the rules and/or threshold levels if there is a perceived need to do so.

A mobile device may be provisioned with one or more applications 12. A monitoring and blocking module 14 may be provisioned to intercept one or more requests 16 from applications 12 to access one or more resources 18. Monitoring and blocking module 14 may log request 16 into log 36 in utilization database 38. A daemon 80 may periodically check utilization database 38, collate the information therein, analyze it (e.g., by applying rules from rules/filters module 20) and notify user 26 with a notification 24, if required. User 26 can provide feedback through update 28. User 26 may send update 28 directly to monitoring and blocking module 14 or update rules in rules/filters module 20. If request 16 is permitted by the rules, or by update 28, request 16 may be forwarded to resource 18.

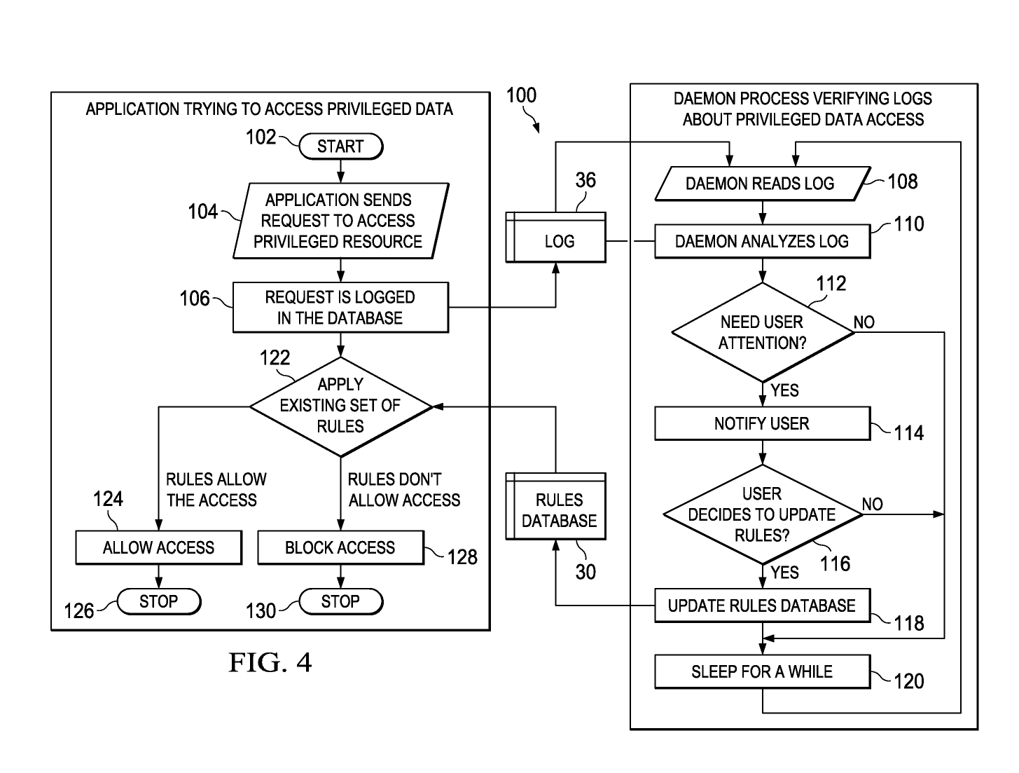

Turning to FIG. 4, FIG. 4 is a simplified flow-chart illustrating example operational steps that may be associated with embodiments of the present disclosure. Operations 100 begin in 102, when system 10 is activated. In 104, application 12 sends request 16 to access privileged resource 18. Request 16 is logged into log 36 in utilization database 38 in 106. Log 36 may contain one or more requests 16 (e.g., from previous access attempts, or from other applications). Daemon 80 may read log 36 in 108. Daemon 80 may analyze log 36 in 110. A determination may be made in 112 whether log 36 (e.g., any information therein) requires user attention. If user attention is required, notification 24 is sent to user 26 in 114. User 26 may decide to update rules in 116. If user 26 decides to update the rules, update 28 may be made to rules database 30 in 118. After database 30 has been updated, or if user 26 decides not to update the rules, daemon 80 may sleep for a while in 120. The daemon process may then revert to 108.

With reference again to the processing of application 12, monitoring and blocking module 14 may apply an existing set of rules from rules database 30 to request 16 in 122. The existing set of rules may comprise the original set of rules and any updates made by user 26. If the rules allow access, access is allowed in 124 and the operations stop at 126. If the rules do not allow access, access is blocked in 128, and the operations stop at 130.

Although the embodiments described herein have referred to mobile applications, it will be apparent that other sets of program files may be evaluated and/or remediated using system 10. The options for threshold levels on privileged resource usage as shown in FIGURES, are for example purposes only. It will be appreciated that numerous other options, at least some of which are detailed herein in this Specification, may be provided in any combination with or exclusive of the options of the various FIGURES.

Software for providing threshold levels on privileged resource usage can be provided at various locations (e.g., within monitoring and blocking module 14). In one example implementation, this software is resident in a mobile device sought to be protected from a security attack (or protected from unwanted, or unauthorized manipulations of a writeable memory area). In a more detailed configuration, this software is specifically resident in a security layer of an operating system, which may include (or otherwise interface with) the components depicted by FIG. 1. In still other embodiments, software could be received or downloaded from a web server (e.g., in the context of purchasing individual end-user licenses for separate devices, applications, etc.) in order to provide this security protection.

In other examples, the functions described herein could involve a proprietary element (e.g., as part of an antivirus solution), which could be provided in (or be proximate to) these identified elements, or be provided in any other device, server, network appliance, console, firewall, switch, information technology (IT) device, etc., or be provided as a complementary solution (e.g., in conjunction with a firewall), or provisioned somewhere in the network. As described herein, mobile devices may include any suitable hardware, software, components, modules, interfaces, or objects that facilitate the operations thereof. This may be inclusive of appropriate algorithms and communication protocols that allow for the effective security protection. In addition, the functions described herein can be consolidated in any suitable manner. Along similar design alternatives, any of the illustrated modules and components of the various FIGURES may be combined in various possible configurations: all of which are clearly within the broad scope of this Specification.

Any of these elements can include memory for storing information to be used in achieving the operations as outlined herein. Additionally, the mobile devices may include a processor that can execute software or an algorithm to perform the activities as discussed in this Specification. The mobile devices may further keep information in any suitable memory (random access memory (RAM), ROM, EPROM, EEPROM, ASIC, etc.), software, hardware, or in any other suitable component, device, element, or object where appropriate and based on particular needs. The information being tracked, sent, received, or stored in system 10 could be provided in any database, register, table, cache, queue, control list, or storage structure, based on particular needs and implementations, all of which could be referenced in any suitable timeframe.

Any of the memory items discussed herein should be construed as being encompassed within the broad term ‘memory.’ Similarly, any of the potential processing elements, modules, and machines described in this Specification should be construed as being encompassed within the broad term ‘processor.’ Each of the mobile devices, computers, network appliances, etc. can also include suitable interfaces for receiving, transmitting, and/or otherwise communicating data or information in a secure environment.

A processor can execute any type of instructions associated with the data to achieve the operations detailed herein in this Specification. In one example, the processor (as shown in the FIGURES) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof.

In certain example implementations, the functions outlined herein may be implemented by logic encoded in one or more tangible non-transitory media (e.g., embedded logic provided in an application specific integrated circuit (ASIC), digital signal processor (DSP) instructions, software (potentially inclusive of object code and source code) to be executed by a processor, or other similar machine, etc.). In some of these instances, memory (as shown in the FIGURES) can store data used for the operations described herein. This includes the memory being able to store software, logic, code, or processor instructions that are executed to carry out the activities described in this Specification.

These elements and/or modules can cooperate with each other in order to perform the activities as discussed herein. In other embodiments, these features may be provided external to these elements, included in other devices to achieve these intended functionalities, or consolidated in any appropriate manner. For example, some of the processors associated with the various elements may be removed, or otherwise consolidated such that a single processor and a single memory location are responsible for certain activities. In a general sense, the arrangement depicted in FIGURES may be more logical in its representation, whereas a physical architecture may include various permutations, combinations, and/or hybrids of these elements. In various embodiments, some or all of these elements include software (or reciprocating software) that can coordinate, manage, or otherwise cooperate in order to achieve the operations outlined herein.

In certain example implementations, the activities outlined herein may be implemented in software. In various embodiments, the software of the system described herein could involve a proprietary element, which could be provided in (or be proximate to) these identified elements, or be provided in any other device, server, network appliance, console, firewall, switch, information technology (IT) device, distributed server, etc., or be provided as a complementary solution, or otherwise provisioned in the network.

Note that with the numerous examples provided herein, interaction may be described in terms of two, three, four, or more network elements and modules. However, this has been done for purposes of clarity and example only. It should be appreciated that the system can be consolidated in any suitable manner. Along similar design alternatives, any of the illustrated modules, components, and elements of FIG. 1 may be combined in various possible configurations, all of which are clearly within the broad scope of this Specification. In certain cases, it may be easier to describe one or more of the functionalities of a given set of flows by only referencing a limited number of elements or components. It should be appreciated that the system of FIG. 1 (and its teachings) is readily scalable and can accommodate a large number of components, as well as more complicated/sophisticated arrangements and configurations. Accordingly, the examples provided should not limit the scope or inhibit the broad teachings of system 10 as potentially applied to a myriad of other architectures.

It is also important to note that the operations described with reference to the preceding FIGURES illustrate only some of the possible scenarios that may be executed by, or within, the system. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion. Substantial flexibility is provided by the system in that any suitable arrangements, chronologies, configurations, and timing mechanisms may be provided without departing from the teachings of the discussed concepts.

What is claimed is:

1. A method comprising:
detecting a request by an application in a mobile device to access a privileged resource;
determining a cumulative usage of the privileged resource by the application; and
performing an action according to a rule if a predefined threshold level of usage triggers the action based on the cumulative usage.

2. The method of claim 1, wherein the action includes:
blocking the request; and
sending a notification to a user.

3. The method of claim 1, wherein the action includes updating a rules database to modify the predefined threshold level of usage associated with the rule.

4. The method of claim 1, wherein the predefined threshold level of usage triggers the action if the cumulative usage occurs within a predefined amount of time.

5. The method of claim 1, wherein the predefined threshold level of usage triggers the action if the cumulative usage exceeds the predefined threshold level of usage.

6. The method of claim 1, further comprising:
monitoring permissions of the application to the privileged resource; and
removing any permissions that have not been used for a predefined time period.

7. The method of claim 6, further comprising sending a notification to a user if the application has not used a permission for the predefined time period.

8. The method of claim 1, further comprising:
sending a notification to the user if there are no rules applicable to the request.

9. The method of claim 1, further comprising:
logging the request into a log in a utilization database.

10. The method of claim 9, further comprising:
reading the log;
collating information in the log; and
analyzing the log.

11. An apparatus comprising:
a memory configured to store data; and
a processor operable to execute instructions associated with the data;
a monitoring and blocking module; and
a rules module, such that the apparatus is configured for:
detecting a request by an application in a mobile device to access a privileged resource;
determining a cumulative usage of the privileged resource by the application; and
performing an action according to a rule if a predefined threshold level of usage triggers the action based on the cumulative usage.

12. The apparatus of claim 11, wherein the action includes:
blocking the request; and
sending a notification to a user.

13. The apparatus of claim 11, wherein the action includes updating a rules database to modify the predefined threshold level of usage associated with the rule.

14. The apparatus of claim 11 further configured for:
monitoring permissions of the application to the privileged resource; and
removing any permissions that have not been used for a predefined time period.

15. The apparatus of claim 11, the apparatus further comprising a utilization database for logging the request into a log, wherein the apparatus is further configured for:
reading the log;
collating information in the log; and
analyzing the log.

16. Logic encoded in non-transitory media that includes code for execution and when executed by a processor is operable to perform operations comprising:
detecting a request by an application in a mobile device to access a privileged resource;
determining a cumulative usage of the privileged resource by the application; and
performing an action according to a rule if a predefined threshold level of usage triggers the action based on the cumulative usage.

17. The logic of claim 16, wherein the action includes:
blocking the request; and
sending a notification to a user.

18. The logic of claim 16, wherein the action includes updating a rules database to modify the predefined threshold level of usage associated with the rule.

19. The logic of claim 16, the operations further comprising:
monitoring permissions of the application to the privileged resource; and
removing any permissions that have not been used for a predefined time period.

20. The logic of claim 16, the operations further comprising:
logging the request into a log in a utilization database;
reading the log;
collating information in the log; and
analyzing the log.
